(19) United States
(12) Patent Application Publication
(10) Pub. No.: US 2010/0135518 A1
(43) Pub. Date: Jun. 3, 2010

(54) Speaker monitor

(76) Inventor: Fredrick L. Jordan, JR., Spring Hill, FL (US)

Correspondence Address: Fredrick L Jordan, Jr., 3123 Deltona Blvd, Spring Hill, FL, 34606, US

(21) Appl. No.: 12/326,848

(22) Filed: Dec. 2, 2008

(51) Int. Cl. H04R 1/02

(52) U.S. Cl. 381/387

(57) ABSTRACT

The cradle mounted monitors allow the performing musician to have Monitors of 100 watts or more that can be used on smaller stages. These Adjustable angle monitors allow musicians to place the monitor in very close Proximity to themselves and yet still be able to hear the monitors full sound Potential.

### TECHNICAL FIELD AND MUSICAL APPLICABILITY OF THE INVENTION

This invention relates to the live music field and in particular to the Reproduction of live music thru the use of personal stage monitors on small To medium size stages of playing locations.

### BACKGROUND OF THE INVENTION

Stage monitors are used by live music performers in order that they may Hear the vocal or the vocal/instrumental music being played by the entire Band.

The monitors of 100 watts or more currently being used are placed on The floor. Most monitors have 2 angled sides 30* & 45* in rare designs the Box may have 2 angles. There are monitors of 100 watts or less that can be Attached to a microphone stand. These monitors do not produce the SPLS Required for most live performances.

The angle of the monitor enclosure and physical height of the individual Musician determines in which location the monitor must be placed so the Musician can fully hear the music being reproduced by the monitor. If the monitor is not located correctly the sound will pass either under or Over the musician. On small to medium stages, the placing of the stage Monitor in the correct location becomes problematic if not impossible.

What is claimed:

1. The monitor speaker box is placed in a cradle stand. The cradle stand can Be constructed of wood or metal tubing. These monitor boxes can be produced In power rating of 150 to 500 watts.

2. By placing the speaker box with a focus beamed lite on the bottom of the Box helps the user to correctly adjust the angle of the box to each individuals Players height.

4. Because of monitors ability to rotate in the cradle-the monitor can be Placed close to the musician with 2′ and yet the musician can receive the full benefit of the monitors sound reproduction. The monitors can be placed in front of back Of the musician.
